(19) United States
(12) Patent Application Publication
(10) Pub. No.: US 2007/0184858 A1
(43) Pub. Date: Aug. 9, 2007

(54) Method of attaching mobile communication tasks to a Subscriber Information Module card and mobile communication device incorporating the same

(75) Inventors: Assaf Landschaft, Muenchen (DE); Laurent Mauguee, Muenchen (DE)

Correspondence Address: HITT GAINES, PC;LSI Corporation, PO BOX 832570, RICHARDSON, TX, 75083, US

(73) Assignee: Agere Systems Inc., Allentown, PA (US)

(21) Appl. No.: 11/350,495

(22) Filed: Feb. 9, 2006

(51) Int. Cl. H04Q 7/20

(52) U.S. Cl. 455/466; 709/206

(57) ABSTRACT

A method of selecting a set of communication parameters on a mobile communication device and a mobile communication device in which the method may be carried out. In one embodiment, the method includes: (1) providing at least two sets of communication parameters, (2) selecting a communication task to be executed by the mobile communication device, (3) selecting a set of communication parameters from the at least two sets of communication parameters depending upon the selected communication task and (4) executing the selected communication task using the selected set of communication parameters.

### TECHNICAL FIELD OF THE INVENTION

The present invention is directed, in general, to mobile communication devices and, more particularly, to a method of attaching mobile communication tasks to a Subscriber Information Module (SIM) card and a mobile communication device incorporating the system or the method.

### BACKGROUND OF THE INVENTION

Today many users of mobile communication devices, in particular GSM (Global System for Mobile Communications) network clients, have more than one mobile telephone number. Typically users at least have separate telephone numbers for personal and business use.

Some users accommodate multiple telephone numbers by carrying multiple mobile communication devices. Unfortunately, this is unwieldy and unattractive to all but the most utilitarian or gadget-oriented users. To address this problem, various attempts have been made to allow a mobile communication device to accommodate multiple telephone numbers.

For example, U.S. Pat. No. 6,641,049 discloses an integrated circuit (IC) card with multiple integral electronic modules. The IC card allows multiple subscription profiles to be stored by acting, in effect, as a plurality of separate SIM cards. However, it is necessary to take the IC out of the mobile communication device, rotate the IC and re-insert it into the device to select one of the multiple subscription profiles. This is highly inconvenient and subjects both the IC and the interior of the mobile communication device to repeated handling and risk of static discharge.

U.S. Pat. No. 6,896,548 describes a SIM card holding apparatus that may accommodate multiple SIM cards in a mobile communication device. The card-holding apparatus allows one of the multiple SIM cards to be coupled to the device.

U.S. Pat. No. 6,356,769 describes an arrangement in that a mobile communication device supports multiple SIM cards through the use of internal and external card readers. A user may select between or among the SIM cards manually or by assigning different priorities to the different reading devices.

All of the above-described attempts at a practical solution require a user to decide that SIM card he wants to use before initiating a communication event. So, for example, if a user has one SIM card for business use and one for personal use, he needs to undertake some manual procedure, probably repeatedly, to use both SIM cards. This is inconvenient to the user, risks damaging the mobile communication device and is error-prone, as the user may not choose the correct SIM card or may forget to make a choice altogether.

Accordingly, what is needed in the art is a better way to allow a mobile communication device to accommodate multiple telephone numbers. What is further needed in the art is a method of attaching mobile communication tasks to a SIM card.

### SUMMARY OF THE INVENTION

To address the above-discussed deficiencies of the prior art, one aspect of the present invention provides a method of selecting a set of communication parameters on a mobile communication device. In one embodiment, the method includes: (1) providing at least two sets of communication parameters, (2) selecting a communication task to be executed by the mobile communication device, (3) selecting a set of communication parameters from the at least two sets of communication parameters depending upon the selected communication task and (4) executing the selected communication task using the selected set of communication parameters.

In another aspect, the present invention provides a mobile communication device. In one embodiment, the mobile communication device includes: (1) at least two memory units with at least two different sets of communication parameters stored therein and (2) a controlling unit having access to the at least two memory units, the controlling unit being configured automatically to select a set of communication parameters from the at least two different sets of communication parameters depending upon a user-selectable communication task.

The foregoing has outlined preferred and alternative features of the present invention so that those skilled in the pertinent art may better understand the detailed description of the invention that follows. Additional features of the invention will be described hereinafter that form the subject of the claims of the invention. Those skilled in the pertinent art should appreciate that they may readily use the disclosed conception and specific embodiment as a basis for designing or modifying other structures for carrying out the same purposes of the present invention. Those skilled in the pertinent art should also realize that such equivalent constructions do not depart from the spirit and scope of the invention.

### BRIEF DESCRIPTION OF THE DRAWINGS

For a more complete understanding of the invention, reference is now made to the following descriptions taken in conjunction with the accompanying drawing, in that:

FIG. 1 illustrates a schematic view of one embodiment of a mobile communication device;

FIG. 2 illustrates a table with exemplary values for a SIM card selection for different types of communication tasks;

FIG. 3 illustrates a table with exemplary options for a SIM card selection;

FIG. 4 illustrates a table with exemplary values for a SIM card selection for different groups of telephone numbers; and

FIG. 5 illustrates a flow diagram of one embodiment of a method of selecting a set of communication parameters on a mobile communication device carried out according to the principles of the present invention.

### DETAILED DESCRIPTION

As stated above, one aspect of the present invention is directed to a method for selecting a set of communication parameters on a mobile communication device. In one embodiment, the method includes providing at least two sets of communication parameters, selecting a communication task to be executed by the mobile communication device, selecting a set of communication parameters from the at least two sets of communication parameters depending upon the selected communication task and executing the selected communication task using the selected set of communication parameters.

Each of the provided sets of communication parameters may include a different subscription profile and may be stored on a SIM card. Each subscription profile typically includes a unique telephone number.

The selecting of the set of communication parameters may advantageously be carried out automatically, so that the user does not have to make a manual selection before executing the requested communication task.

The communication task preferably is selected from all communication tasks the mobile communication device is capable of performing. Accordingly, the type of the selected communication task may, for example, be any one of dialing a telephone number, sending a short message (SMS), sending a multimedia message (MMS), sending an e-mail message, gaining access to a website, or any other communication task for that the mobile communication device is equipped.

The selecting of the set of communication parameters depending upon the selected communication task may be carried out in various ways. In one embodiment, the set of communication parameters is selected depending upon the type of the selected communication task. As above, the type may any of those stated above.

Any user-selectable communication task may be associated with a pre-determined destination address used for establishing a connection with another communication device. A destination address in this respect may, for example, be a telephone number, an e-mail address or an Internet address. In another embodiment, the selected communication task includes selecting a pre-determined destination address, in particular a telephone number, an e-mail address or an Internet address, and the set of communication parameters is selected depending upon the selected destination address.

Different mobile communication networks often charge different service rates depending upon communication type. For example telephone calls, SMS or Internet access charges may vary from one network to another, and charges within the same network typically vary depending upon the day and the time of day. Accordingly, the sets of communication parameters may include tariff information for the corresponding mobile communication network and the user-specific subscription. Correspondingly, the method may include selecting a set of communication parameters depending upon tariff information for the selected communication task. In this manner, one of several SIM cards in a mobile communication device may be selected such that the lowest rate for the selected communication task is incurred.

The selecting of the set of communication parameters may be carried out by retrieving information from a stored lookup table. Such a lookup table may be used for the above-described variations for performing the selecting of the set of communication parameters.

Accordingly, the type of the selected communication task may be associated with at least one set of communication parameters by means of the lookup table. Also the destination address of the selected communication task may be associated with at least one set of communication parameters by means of the lookup table.

In yet another embodiment, the destination address of the selected communication task is a member of a group of destination addresses, and the lookup table is used to associate the group with at least one set of communication parameters. For example, the functionality of organizing the telephone numbers stored in a mobile communication device into predefined caller groups, that is often already the case in today's mobile communication devices, may be used for automatically selecting one of several SIM cards depending upon the caller group associated with a telephone number to be called. The entries of the lookup table, of course, may be user-definable.

The lookup table may provide more than one matching sets of communication parameters for the selected communication tasks. The lookup table may provide different predefined priorities for these sets of communication parameters. In such case, the method may include selecting the set of communication parameters having the highest priority associated with the selected communication task.

Priorities associated with sets of communication parameters may also be used to determine the order in that attempts to execute a certain communication task consecutively are made. For example, an entry in the lookup table may call for a reading device that is not present, that does not hold a SIM card (for example, an externally connectable SIM card reader), or that cannot perform the communication task in question. In such case, executing a communication task fails if the reading device or the SIM card is not present. Accordingly, the method may include the step of consecutively selecting the set of communication parameters with the next lower priority associated with the selected communication task in case of failure to execute the selected communication task.

Although the focus of the present discussion has been on user-initiated communication, the present invention encompasses the concept that incoming calls may be automatically associated with the corresponding set of communication parameters by means of the called telephone number.

A mobile communication device includes at least two memory units with at least two different sets of communication parameters stored therein and a controlling unit having access to the at least two memory units. In such case, the controlling unit may be configured automatically to select a set of communication parameters from the at least two different sets of communication parameters depending upon a user-selectable communication task.

The present invention contemplates that the memory units may be part of SIM cards, and the sets of communication parameters may include corresponding subscription profiles. Depending upon the design of the mobile communication device, the different subscription profiles may be stored on the same or on different SIM cards and the reading devices for reading information stored on the SIM cards may be integrated in the mobile communication device or may be externally attachable.

The mobile communication device may be configured for performing different types of communication tasks, in particular dialing a telephone number, sending a short message (SMS), sending a multimedia message (MMS), sending an e-mail message and gaining access to a website.

The inventive device may include a memory unit with a lookup table stored therein to allow selection of a set of communication parameters depending upon a selection made by the user to perform a certain communication task. In such case, the controlling unit may be configured to retrieve information from the lookup table.

The lookup table may include a mapping of user-selectable communication tasks to available sets of communication parameters. The mapping may include information on types, destination addresses and/or groups of destination addresses of user-selectable communication tasks.

The lookup table further may include priorities associated with at least two sets of communication parameters associated with the same user-selectable communication task. In such case, the device may be configured consecutively to select different sets of communication parameters that are associated with the same user-selectable communication task and have different associated priorities, with descending priority and starting with the highest priority, until the selected communication task is carried out successfully or all sets of communication parameters associated with the communication task have been attempted. To customize the automatic selection of sets of communication parameters corresponding to user needs, the entries of the lookup table may be user-definable. For selecting the set of communication parameters that provides the least cost for a selected communication task, the lookup table may include tariff information corresponding to the available sets of communication parameters.

To provide an easy implementation and/or specific adaptation of the invention, a digital storage medium is proposed, in particular a chip, including electronically readable control instructions configured to execute any of the embodiments of the above described method, when inserted in a mobile communication device having the above described features.

Having described many alternative embodiments of aspects of the present invention in general, the embodiments will be further described with reference to the FIGUREs. Accordingly, referring initially to FIG. 1, illustrated is a highly schematic block diagram of components of an exemplary embodiment of a mobile communication device, namely a mobile telephone 1. For communication purposes, the mobile telephone 1 includes a communication transceiver 10 configured to enable communication via a communication network 100. The communication network 100 in the illustrated embodiment is a cellular network supporting the well-known Global System for Mobile Communications (GSM) standard to which the mobile telephone 1 is connectable. The mobile telephone 1 further includes a microprocessor 40 as a central controller. Operating software, user-defined device settings and user data, such as telephone-book entries or received and sent messages are stored in a memory unit 70. A user interface is provided by an input 42 and an output 44, which typically respectively include a keypad and a display.

In the illustrated embodiment, the mobile telephone 1 is configured for use with two SIM memory modules 52 and 54, provided as exchangeable SIM cards. The microprocessor 10 has parallel access to both SIM memory modules 52 and 54. The illustrated embodiment of the mobile telephone 1 is provided with a software application, executable by the microprocessor 10, that is configured to automatically select either the SIM card 52 or the SIM card 54, depending upon the choice of a user-selectable communication task.

A communication task may be any kind of communication activity that the user of a mobile communication device may perform over a mobile communication network, in particular a GSM network. The invention, however, is not limited to GSM networks and corresponding mobile communication devices, but may also be employed in any other existing or later-deployed mobile communication network.

Examples of communication tasks include sending a short message corresponding to SMS standards to a selected telephone number, sending an e-mail message to a selected e-mail address, dialing a selected telephone number for establishing a voice connection, gaining access to a selected web site.

A mapping between communication tasks and SIM cards is provided in a lookup table 60. The lookup table 60 may be provided as a separate memory unit or it may be integrated in the device memory 70. Each communication task may map to one or more SIM card profiles. If a communication task maps to more than one SIM card profile, the profiles are provided with corresponding priorities.

When the user of the mobile telephone 1 decides to perform a communication task, the illustrated embodiment of the mobile telephone 1 automatically switches to the SIM card profile that matches the specific communication task based on the entries of the lookup table 60 and then attempts to execute the communication task. If more than one SIM card profile is associated with a communication task, the SIM card profile with the highest priority is selected. In case of failure to execute the communication task, the mobile telephone 1 is configured to automatically select any further SIM card profile associated with the selected communication task in descending order of priority until the communication task is either successfully executed or no further SIM card profile is available.

In the illustrated embodiment, two SIM card profiles stored on the respective SIM cards 52, 54 are provided. However, any other number of SIM card profiles, stored on one or on several memory units, also lies within the scope of the invention.

For adapting the selection of the SIM card profile to be used for a communication task corresponding to user needs, the mapping parameters stored in the lookup table 60 are editable by the user of the mobile telephone 1. For this purpose preferably an corresponding menu selection is provided in the user interface of the mobile telephone 1.

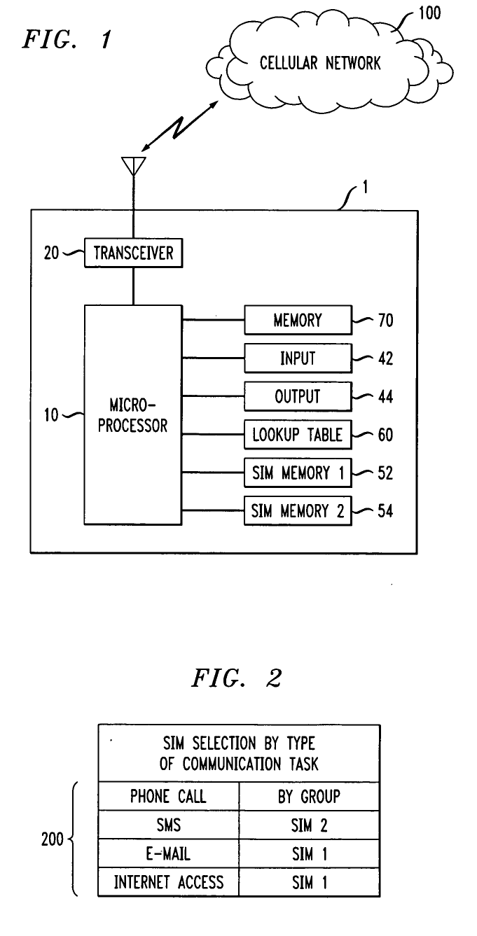

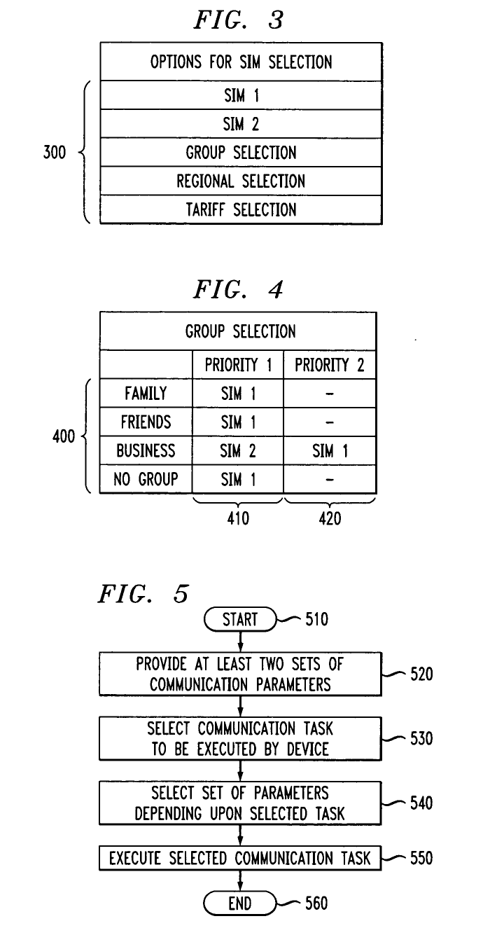

FIGS. 2 through 4 exemplary show selection options for user-definable mapping parameters. FIG. 2 indicates that the user may select different selection options for different types 200 of communication tasks. Exemplary available options 300 are shown in FIG. 3. Accordingly, the user may either select a fixed association of a type of communication task with one of the available SIM card profiles, or he may select a group, a regional or a tariff selection.

In the exemplary communication task types (SMS, e-mail and Internet access), a fixed association with either SIM card 52, 54 is selected. This may for example be of advantage if the network provider corresponding to the selected SIM card offers the corresponding type of communication task at a good prize. For telephone calls a group selection is selected allowing the definition of further parameters, as shown in FIG. 4.

In the illustrated embodiment, the telephone numbers stored in the mobile telephone 1 are organized in different groups 400. If a telephone number is selected for a telephone call that is not a member of a group it is automatically associated with the group “No group.” Also shown is the option to associate more than one SIM card profile with a communication task and to define corresponding priorities 410, 420. In the example of FIG. 4, the group “Business” is associated with the second SIM card profile, i.e., the SIM card 54 of FIG. 1, with high priority and with the first SIM card profile, i.e., the SIM card 52 of FIG. 1, with low priority. All other groups are only associated with SIM card profile 1. This could be, for example, to accommodate a user having one SIM card for personal calls and another for business calls. By defining a group with telephone numbers for business purposes, the corresponding SIM card profile may be automatically selected. If the SIM card for business purposes is not always present, the other SIM card may be selected, as is the case in the illustrated embodiment.

Similar to the described group selection, a regional selection may be provided in which telephone numbers are categorized by region, for example, national, overseas or specific countries. If the SIM card profiles include tariff information, a selection may be based on tariff, resulting in selection of the SIM card profile having lower rates for the given time of day.

Turning now to FIG. 5, illustrated is a flow diagram of one embodiment of a method of selecting a set of communication parameters on a mobile communication device carried out according to the principles of the present invention. The method begins in a start step 510. In a step 520, at least two sets of communication parameters are provided. In a step 530, a communication task to be executed by the mobile communication device is selected. In a step 540, a set of communication parameters is selected from the at least two sets of communication parameters depending upon the selected communication task. In a step 550, the selected communication task is executed using the selected set of communication parameters. The method ends in an end step 560. The steps generally described outlined in the method of FIG. 5 may be varied or enhanced as described or claimed herein.

Although the present invention has been described in detail, those skilled in the pertinent art should understand that they may make various changes, substitutions and alterations herein without departing from the spirit and scope of the invention in its broadest form.

What is claimed is:

1. A method of selecting a set of communication parameters on a mobile communication device, comprising:
providing at least two sets of communication parameters;
selecting a communication task to be executed by said mobile communication device;
selecting a set of communication parameters from said at least two sets of communication parameters depending upon said selected communication task; and
executing said selected communication task using said selected set of communication parameters.

2. The method as recited in claim 1 wherein said selecting said set of communication parameters is carried out automatically.

3. The method as recited in claim 1 wherein each of said at least two sets of communication parameters comprises a separate subscription profile.

4. The method as recited in claim 1 wherein each of said at least two sets of communication parameters is stored in a separate SIM card.

5. The method as recited in claim 1 wherein said communication task is selected from the group consisting of:
dialing a telephone number,
sending an SMS message,
sending an MMS multimedia message,
sending an e-mail message, and
gaining access to a website.

6. The method as recited in claim 1 wherein one of said at least two sets of communication parameters is selected depending upon said type of said selected communication task.

7. The method as recited in claim 1 wherein said selecting said communication task comprises selecting a pre-determined destination address and said selecting said set of communication parameters depends upon said selecting said pre-determined destination address.

8. The method as recited in claim 1 wherein one of said at least two sets of communication parameters is selected depending upon tariff information for said selected communication task.

9. The method as recited in claim 1 wherein said selecting said set of communication parameters comprises retrieving information from a stored lookup table.

10. The method as recited in claim 9 wherein said lookup table associates a type of said selected communication task with at least one set of communication parameters.

11. The method as recited in claim 9 wherein said lookup table associates a destination address of said selected communication task with at least one set of communication parameters.

12. The method as recited in claim 9 wherein said destination address of said selected communication task is a member of a group of destination addresses and said lookup table associates said group of destination addresses with at least one set of communication parameters.

13. The method as recited in claim 9 wherein entries of said lookup table are user-definable.

14. The method as recited in claim 9 wherein said selected communication task is associated with said at least two sets of communication parameters based on predefined priorities contained in said lookup table and said predefined priorities associated with said selected communication task determine said selection of said set of communication parameters.

15. The method as recited in claim 14 further comprising consecutively selecting said set of communication parameters with a next lower priority associated with said selected communication task in case of failure to execute said selected communication task.

16. A mobile communication device, comprising:
at least two memory units with at least two different sets of communication parameters stored therein; and
a controlling unit having access to said at least two memory units, said controlling unit being configured automatically to select a set of communication parameters from said at least two different sets of communication parameters depending upon a user-selectable communication task.

17. The mobile communication device as recited in claim 16 wherein said at least two memory units comprise at least two separate SIM cards.

18. The mobile communication device as recited in claim 16 wherein said at least two memory units comprise one SIM card with at least two separate subscription profiles stored thereon.

19. The mobile communication device as recited in claim 16 wherein each set of communication parameters comprises a separate subscription profile.

20. The mobile communication device as recited in claim 16 wherein said user-selectable communication task is selected from the group consisting of:
dialing a telephone number,
sending an SMS message,
sending an MMS message,
sending an e-mail message and
gaining access to a website.

21. The mobile communication device as recited in claim 16 further comprising a memory unit with a lookup table stored therein, said controlling unit being configured to retrieve information from said lookup table.

22. The mobile communication device as recited in claim 21 wherein said lookup table comprises a mapping of user-selectable communication tasks to said sets of communication parameters.

23. The mobile communication device as recited in claim 21 wherein said lookup table comprises a mapping of types of user-selectable communication tasks to said sets of communication parameters.

24. The mobile communication device as recited in claim 21 wherein said lookup table comprises a mapping of destination addresses of user-selectable communication tasks to said sets of communication parameters.

25. The mobile communication device as recited in claim 21 wherein said lookup table comprises a mapping of groups of destination addresses of user-selectable communication tasks to said sets of communication parameters.

26. The mobile communication device as recited in claim 21 wherein said entries of said lookup table are user-definable.

27. The mobile communication device as recited in claim 21 wherein said lookup table comprises tariff information of said sets of communication parameters.

28. The mobile communication device as recited in claim 21 wherein said lookup table comprises priorities associated with at least two sets of communication parameters associated with said same user-selectable communication task.
